(19) United States
(12) Patent Application Publication
(10) Pub. No.: US 2023/0059911 A1
(43) Pub. Date: Feb. 23, 2023

(54) SYSTEMS FOR USE IN PROCESSING RUBBER SEALS

(71) Applicant: Honda Motor Co., Ltd., Tokyo (JP)

(72) Inventors: Benjamin MacArthur, Barrie (CA); Mehul Rana, Brampton (CA); Samuel Rosati, Toronto (CA)

(21) Appl. No.: 17/406,172

(22) Filed: Aug. 19, 2021

(51) Int. Cl. B60J 10/00; B60J 10/60

(52) U.S. Cl. CPC B60J 10/45; B60J 10/60

(57) ABSTRACT

A system for use in processing rubber seals, the system including at least one insulated cabinet having a first end, a second end, and a first dimension defined therebetween. The at least one insulated cabinet further includes a side wall defining an interior of the at least one insulated cabinet, and an access window defined in the side wall. A cover is configured to at least partially restrict airflow through the access window. A hanger is coupled at the first end of the at least one insulated cabinet, wherein the first dimension is oriented to define a height of the at least one insulated cabinet such that a plurality of the rubber seals are suspendable from the hanger within the interior. A heater is thermally coupled to the at least one insulated cabinet, wherein the heater is configured to heat the interior to greater than a predefined temperature.

### BACKGROUND

The present disclosure relates generally to vehicle assembly processes and, more specifically, to systems for use in preheating elastomeric weather strips to facilitate their installation onto a vehicle.

Motor vehicles have many openings covered by swinging panels such as doors, trunks, tailgates, and hatchbacks. Weather strips are used to seal these openings to prevent rain, dirt, mud, noise, external temperatures, and the like from entering the vehicle through the openings. Many known weather strips are fabricated from a pliable material, such as rubber, which enables the weather strip to be compressed to tightly seal any gaps between the vehicle body and its swinging panels. Weather strips are typically manufactured separately from the vehicle body and then forced onto the vehicle, oftentimes manually by a technician, along the perimeter of the openings. Heating rubber is known to enhance its pliability such that in at least some known installation applications, the weather strips are heated prior to being installed onto the vehicle body. Such heating generally requires the weather strips to be preheated in a large heated enclosure positioned along the vehicle assembly line. Heating the interior volume of the enclosure may be costly and inefficient, and may also result in inconsistent temperature distribution across the interior volume. In addition, the enclosure may have a large physical footprint and be immobile, which limits its versatility and use.

### BRIEF DESCRIPTION

In one aspect, a system for use in processing rubber seals is provided. The system includes at least one insulated cabinet including a first end, a second end, and a first dimension defined therebetween. The at least one insulated cabinet further includes a side wall defining an interior of the at least one insulated cabinet, and an access window defined in the side wall. A cover is configured to at least partially restrict airflow through the access window. A hanger is coupled at the first end of the at least one insulated cabinet, wherein the first dimension is oriented to define a height of the at least one insulated cabinet such that a plurality of the rubber seals are suspendable from the hanger within the interior. A heater is thermally coupled to the at least one insulated cabinet, wherein the heater is configured to heat the interior to greater than a predefined temperature.

In another aspect, a system for use in processing rubber seals is provided. The system includes at least one insulated cabinet including a first end and a second end, defining a height dimension therebetween, and a depth dimension. The at least one insulated cabinet further includes a side wall defining an interior sized to receive a plurality of the rubber seals therein, and an access window defined in the side wall. A cover is configured to at least partially restrict airflow through the access window. A hanger is coupled at the first end of the at least one insulated cabinet, wherein the hanger is oriented to extend in the depth dimension such that the plurality of the rubber seals are stackable on the hanger in the depth dimension. A heater is thermally coupled to the at least one insulated cabinet, wherein the heater is configured to heat the interior to greater than a predefined temperature.

In yet another aspect, a system for use in processing rubber seals is provided. The system includes at least one insulated cabinet including a first end and a second end, defining a height dimension therebetween, a depth dimension, and a width dimension. The depth dimension and the width dimension are shorter than the height dimension. The at least one insulated cabinet further includes a side wall defining an interior sized to receive a plurality of the rubber seals therein, and an access window defined in the side wall. A cover is configured to at least partially restrict airflow through the access window. A hanger is coupled at the first end of the at least one insulated cabinet, wherein the hanger is oriented to extend in the depth dimension such that the plurality of the rubber seals are stackable on the hanger in the depth dimension. A heater is thermally coupled to the at least one insulated cabinet, wherein the heater is configured to heat the interior to greater than a predefined temperature.

### BRIEF DESCRIPTION OF THE DRAWINGS

FIG. 1 is a front perspective view of a system that may be used to process rubber seals.

FIG. 2 is a rear perspective view of the system shown in FIG. 1.

### DETAILED DESCRIPTION

The embodiments described herein relate generally to systems for use in preheating rubber weather strips to facilitate their installation onto a vehicle. Trunk seals, and rubber weather strips in general, require less force to apply when they are exposed to repeatable and consistent heat. At least some weather strips are pre-fabricated as closed-loop structures sized to fit the perimeters of the vehicle openings to be sealed. The weather strips are generally flexible, but at room temperature may be difficult to install onto a vehicle. Accordingly, the systems described herein include one or more insulated cabinets that are adapted to retain heat and store a plurality of weather strips therein. The cabinets include a side wall that defines an interior, and an access window that provides access to the interior. A hanger coupled within the interior is capable of receiving multiple weather strips and holding them within the interior. In addition, the cabinet is sized to store weather strips suspended from the hanger therein, while also being limited in size to enable the interior to be heated in a consistent, evenly distributed, and efficient manner. Because of the limited capacity of the cabinets, multiple cabinets may be used to preheat enough weather strips required to complete a job, for example. Accordingly, multiple cabinets may be mounted on a base, defining a system that is lightweight, portable, and dynamically versatile.

In use, the preheated weather strips may be retrieved from the insulated cabinets through the access window. The access window may be at least partially sealed with a cover such that heat is retained within the interior of the cabinet. The cover is also designed to enable the weather strips to be retrieved from the cabinets in a quick and efficient manner, while also being self-sealing for retaining the heat therein. The preheated and now pliable weather strips may then be pressed along the perimeter of a vehicle opening with less force, thereby reducing strain on a technician.

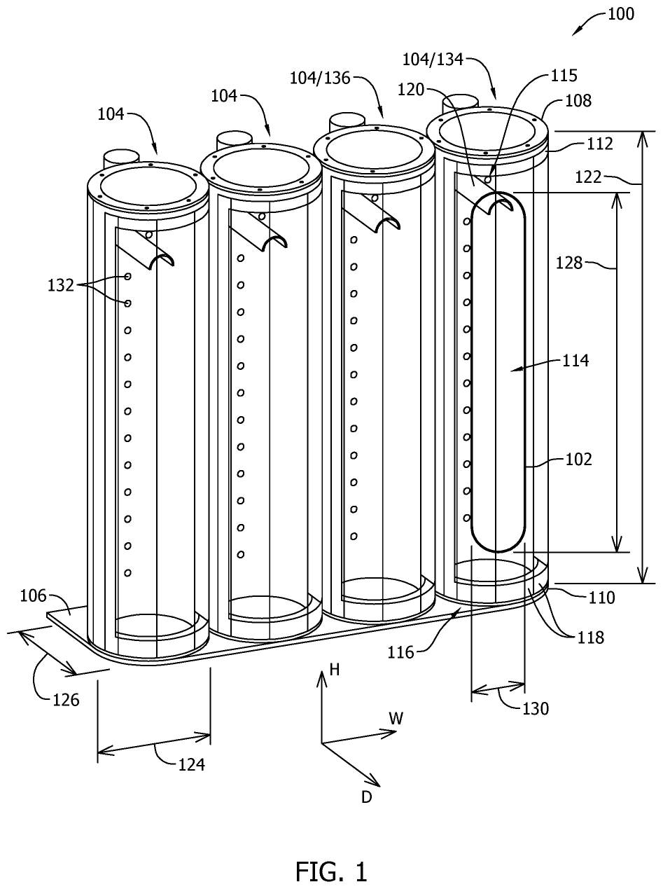

FIG. 1 is a front perspective view of a system 100 that may be used to process rubber seals 102. In the exemplary embodiment, system 100 includes at least one insulated cabinet 104 coupled to a base 106. Base 106 is flat sheet of material configured to receive insulated cabinet 104 thereon. As illustrated in FIG. 1, a plurality of insulated cabinets 104 may be coupled to base 000 to increase the number of rubber seals 102 that may be preheated by system 100 at one time. Thus, base 106 enables insulated cabinets 104 to be coupled together and selectively transportable to a desired location as a single portable unit.

A single insulated cabinet 104 is described below in further detail, but it should be understood that the following is applicable to each insulated cabinet 104 in system 100. In the exemplary embodiment, insulated cabinet 104 includes a first end 108, a second end 110, and a side wall 112 defining an interior 114 thereof. An access window 115 is defined in side wall 112 for providing access to interior 114. Insulated cabinet 104 further includes a cover 116 extending across access window 115. For example, cover 116 may be any self-sealing door, flap, or other physical member that provides selective access to interior 114 while also at least partially restricting airflow through access window 115. Accordingly, cover 116 restricts heated air from escaping interior 114 through access window 115, which facilitates maintaining adequate and consistent heating within insulated cabinet 104 for maintaining rubber seals 102 at a desired temperature. In the exemplary embodiment, cover 116 includes a plurality of strips 118 of material (i.e., a strip curtain) hanging from first end 108 of insulated cabinet 104. Adjacent strips 118 may be overlapping or aligned side-by-side to facilitate sealing access window 115. Accordingly, a technician may gain access to interior 114 by reaching between adjacent strips 118.

Insulated cabinet 104 includes a hanger 120 coupled at first end 108 thereof such that rubber seals 102 are suspendable therefrom. In the exemplary embodiment, rubber seals 102 are closed-loop structures that are flexible and elastomeric at room temperature. Accordingly, rubber seals 102 received on hanger 120 extend in a height dimension H and a width dimension W of insulated cabin 000 when suspended within interior 114. In one embodiment, hanger 120 is coupled to side wall 112, and is oriented to extend from side wall 112 in depth dimension D. Accordingly, a plurality of rubber seals 102 are stackable in depth dimension D on hanger 120 to increase the capacity of insulated cabinet.

Referring to FIG. 1, insulated cabinet 104 has a first dimension 122 defined between first end 108 and second end 110 (i.e., in height dimension H), a second dimension 124 defined in width dimension W, and a third dimension 126 defined in depth dimension D. In the exemplary embodiment, first dimension 122 is longer than both second dimension 124 and third dimension 126, and second dimension 124 and third dimension 126 are approximately equal in length. At least first dimension 122 is selected to enable rubber seals 102 to be freely suspendable from hanger 120 within interior 114. For example, first dimension 122 may be longer than second dimension 124 and third dimension 126 by at least a factor of 4, at least a factor of 5, at least a factor of 6, or a factor defined within a range between about 4 and 10. When suspended from hanger 120, rubber seals 102 may have a suspended length 128 and a suspended width 130, wherein suspended length 128 is approximately half the total length of rubber seals 102. Accordingly, insulated cabinet 104 is sized such that first dimension 122 is longer than suspended length 128 to enable rubber seals 102 to be suspended from hanger 120 with reduced crowding at second end 110. Reducing crowding of rubber seals 102 at second end 110 enables heat to be provided to rubber seals 102 in a more uniform and evenly distributed manner.

Dimensions 122, 124, and 126 are also selected such that interior 114 defines a limited volume that may be heated in a consistent, evenly distributed, and efficient manner. For example, in one embodiment, dimensions 122, 124, and 126 are selected to be greater than the dimensions of rubber seals 102 suspended from hanger 120 by no more than a predetermined percentage of the rubber seal dimensions. For example, first dimension 122 may be selected to be no more than about 125 percent, no more than about 120 percent, no more than about 115 percent, no more than about 110 percent, or no more than about 105 percent of suspended length 128 of rubber seals 102. Second dimension 124 may be selected to be no more than about 125 percent, no more than about 120 percent, no more than about 115 percent, no more than about 110 percent, or no more than about 105 percent of suspended width 130 of rubber seals 102. Third dimension 126 may be selected based on a desired capacity of insulated cabinet 104, wherein the capacity of insulated cabinet 104 increases proportionally as third dimension 126 increases. Accordingly, limiting the length of dimensions 122, 124, and 126 facilitates defining a limited interior volume of insulated cabinet 104 that may be heated and maintained at a desired temperature in an efficient and cost-saving manner.

As described above, access window 115 is defined in side wall 112 to provide access to interior 114. Access window 115 may have any size and/or shape that enables insulated cabinet 104 to function as described herein. In the exemplary embodiment, access window 115 extends substantially the entire length of first dimension 122. Accordingly, rubber seals 102 may be selectively received within, and then removed from, interior 114 through access window 115 with minimal effort and enhanced accessibility.

Also as described above, insulated cabinet 104 is heated to enhance the pliability of rubber seals 102 stored therein. Insulated cabinet 104 may be heated by any mechanism or technique that enables system 100 to function as described herein. In the exemplary embodiment, at least one heating vent 132 is defined in side wall 112 for channeling heated air (not shown) into interior 114. For example, a plurality of heating vents 132 may be defined in side wall 112 and arranged and/or aligned in first dimension 122 along side wall 112. Accordingly, as will be described in more detail below, heating vents 132 are arranged to provide substantially uniform heat along the height of insulated cabinet 104.

Insulated cabinet 104 may be fabricated of any material that enables system 100 to function as described herein. In one embodiment, insulated cabinet 104 is fabricated from a non-metallic material such as, but not limited to including, polypropylene, polyethylene, polyvinylchloride, polystyrene, polyethylenetheraphthalate, and polycarbonate. In addition, side wall 112 may have any thickness that enables insulated cabinet 104 to function as described herein. For example, the side wall thickness may be defined within a range between about 0.05 inch and about 0.5 inch, between about 0.1 inch and about 0.5 inch, and between about 0.1 inch and about 0.25 inch. Accordingly, insulated cabinet 104 enables system 100 to be lightweight and portable, and capable of retaining heat therein better than thermally conductive metallic counterparts.

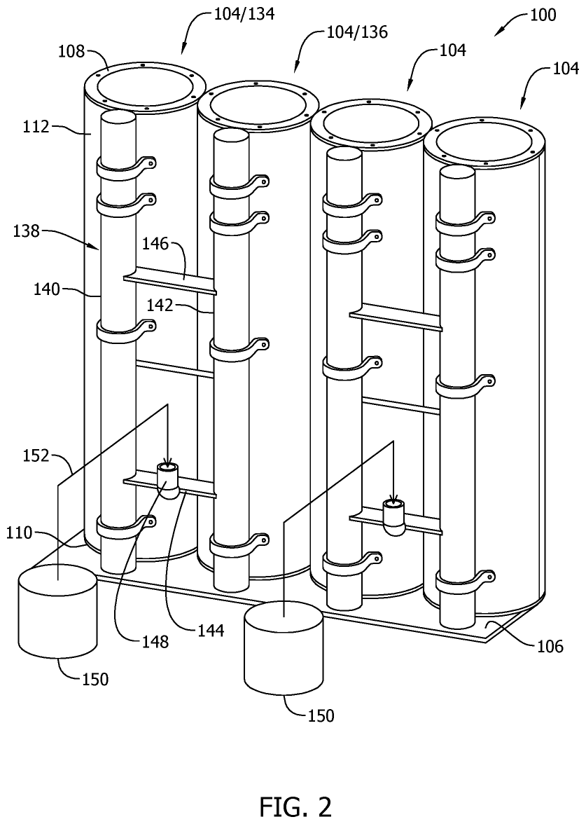

FIG. 2 is a rear perspective view of system 100 including at least a first insulated cabinet 134 and a second insulated cabinet 136. In the exemplary embodiment, a conduit assembly 138 is coupled to insulated cabinets 134 and 136. Conduit assembly 138 includes a first conduit 140 coupled to first insulated cabinet 134, a second conduit 142 coupled to second insulated cabinet 136, and a first connector 144 and a second connector 146 coupled between conduits 140 and 142. Thus, conduit assembly 138 defines an interconnected network providing flow communication between insulated cabinets 134 and 136. For example, conduits 140 and 142 are coupled in flow communication with heating vents 132 (shown in FIG. 1) in insulated cabinets 134 and 136. Accordingly, heat may be provided to insulated cabinets 134 and 136 from a single heat source, which facilitates equalizing the temperature therebetween.

In the exemplary embodiment, first connector 144 includes a port 148 defined therein. System 100 also includes a heater 150 coupled in flow communication with conduit assembly 138 via port 148. Heater 150 may be any device that enables insulated cabinets 134 and 136 to be heated to a desired temperature. In one embodiment, heater 150 generates heated air 152, and channels heated air 152 towards insulated cabinets 134 and 136. Port 148 is configured to receive heated air 152 from heater 150, and conduit assembly 138 channels heated air 152 towards insulated cabinets 134 and 136. Heater 150 may be selectively coupled and uncoupled from conduit assembly 138 to further enhance the portability of system 100. In some embodiments, system 100 also includes a temperature sensor within interior 114 (shown in FIG. 1) and a controller (not shown), wherein the controller receives temperature data from the sensor and controls operation of heater 150 based on the temperature data. The controller may regulate the temperature within insulated cabinets 134 and 136 to be no greater than a preset temperature threshold. The preset temperature threshold may be about 60° C., about 50° C., about 40° C., or about 30° C.

The embodiments described herein relate to systems for use in preheating rubber weather strips to facilitate their installation onto a vehicle. The systems described herein include one or more insulated cabinets in the form of polymer columns that are adapted to retain heat and store a plurality of weather strips therein. The cabinet is limited in size to enable the interior to be heated in a consistent, evenly distributed, and efficient manner. Once heated, the preheated weather strips may be retrieved from the insulated cabinets for installation onto a vehicle, sometimes manually by a technician. Heating the weather strips enhances their pliability, such that installation of the weather strips may be achieved with reduced strain and improved ergonomic efficiency for the technician.

Exemplary embodiments of a system for use in preheating rubber seals in preparation for installation onto a vehicle are described above in detail. Although the system is described and illustrated in association with weather strips for use in sealing vehicle openings, the invention is also intended for use with other assemblies as well. Moreover, it should also be noted that the components of the invention are not limited to the specific embodiments described herein, but rather, aspects of each component may be utilized independently and separately from other components and methods described herein.

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for use in processing rubber seals, the system comprising:
at least one insulated cabinet comprising a first end, a second end, and a first dimension defined therebetween, the at least one insulated cabinet further comprising a side wall defining an interior of the at least one insulated cabinet, and an access window defined in the side wall;
a cover configured to at least partially restrict airflow through the access window;
a hanger coupled at the first end of the at least one insulated cabinet, wherein the first dimension is oriented to define a height of the at least one insulated cabinet such that a plurality of the rubber seals are suspendable from the hanger within the interior; and
a heater thermally coupled to the at least one insulated cabinet, wherein the heater is configured to heat the interior to greater than a predefined temperature.

2. The system in accordance with claim 1, wherein the at least one insulated cabinet further comprises a second dimension and a third dimension that are shorter than the first dimension.

3. The system in accordance with claim 2, wherein the first dimension is longer than the second dimension and the third dimension by at least a factor of 4.

4. The system in accordance with claim 1 further comprising a base, wherein the at least one insulated cabinet comprises a first insulated cabinet and a second insulated cabinet coupled to the base.

5. The system in accordance with claim 4 further comprising a conduit assembly coupled to the first and second insulated cabinets, wherein the conduit assembly comprises a port configured to receive heated air discharged from the heater, and wherein the conduit assembly is configured to channel the heated air towards the first and second insulated cabinets.

6. The system in accordance with claim 5 further comprising at least one heating vent defined in the side wall, wherein the conduit assembly is configured to channel the heated air from the heater towards the at least one heating vent.

7. The system in accordance with claim 5, wherein the at least one heating vent comprises a plurality of heating vents arranged in the first dimension along the side wall.

8. The system in accordance with claim 1, wherein the at least one insulated cabinet is fabricated from a non-metallic material.

9. A system for use in processing rubber seals, the system comprising:
at least one insulated cabinet comprising a first end and a second end, defining a height dimension therebetween, and a depth dimension, the at least one insulated cabinet further comprising a side wall defining an interior sized to receive a plurality of the rubber seals therein, and an access window defined in the side wall;
a cover configured to at least partially restrict airflow through the access window;
a hanger coupled at the first end of the at least one insulated cabinet, wherein the hanger is oriented to extend in the depth dimension such that the plurality of the rubber seals are stackable on the hanger in the depth dimension; and
a heater thermally coupled to the at least one insulated cabinet, wherein the heater is configured to heat the interior to greater than a predefined temperature.

10. The system in accordance with claim 9, wherein the at least one insulated cabinet further comprises a width dimension, wherein the depth dimension and the width dimension are shorter than the height dimension

11. The system in accordance with claim 10, wherein the height dimension is longer than the depth dimension and the width dimension by at least a factor of 4.

12. The system in accordance with claim 9 further comprising a base, wherein the at least one insulated cabinet comprises a first insulated cabinet and a second insulated cabinet coupled to the base.

13. The system in accordance with claim 12 further comprising a conduit assembly coupled to the first and second insulated cabinets, wherein the conduit assembly comprises a port configured to receive heated air discharged from the heater, and wherein the conduit assembly is configured to channel the heated air towards the first and second insulated cabinets.

14. The system in accordance with claim 13 further comprising at least one heating vent defined in the side wall, wherein the conduit assembly is configured to channel the heated air from the heater towards the at least one heating vent.

15. The system in accordance with claim 9, wherein the at least one insulated cabinet is fabricated from a non-metallic material

16. A system for use in processing rubber seals, the system comprising:
at least one insulated cabinet comprising a first end and a second end, defining a height dimension therebetween, a depth dimension, and a width dimension, wherein the depth dimension and the width dimension are shorter than the height dimension, and wherein the at least one insulated cabinet further comprises a side wall defining an interior sized to receive a plurality of the rubber seals therein, and an access window defined in the side wall;
a cover configured to at least partially restrict airflow through the access window;
a hanger coupled at the first end of the at least one insulated cabinet, wherein the hanger is oriented to extend in the depth dimension such that the plurality of the rubber seals are stackable on the hanger in the depth dimension; and
a heater thermally coupled to the at least one insulated cabinet, wherein the heater is configured to heat the interior to greater than a predefined temperature.

17. The system in accordance with claim 16, wherein the height dimension is longer than the depth dimension and the width dimension by at least a factor of 4.

18. The system in accordance with claim 16 further comprising a base, wherein the at least one insulated cabinet comprises a first insulated cabinet and a second insulated cabinet coupled to the base.

19. The system in accordance with claim 18 further comprising a conduit assembly coupled to the first and second insulated cabinets, wherein the conduit assembly comprises a port configured to receive heated air discharged from the heater, and wherein the conduit assembly is configured to channel the heated air towards the first and second insulated cabinets.

20. The system in accordance with claim 19 further comprising at least one heating vent defined in the side wall, wherein the conduit assembly is configured to channel the heated air from the heater towards the at least one heating vent.
